(19) United States
(12) Patent Application Publication
(10) Pub. No.: US 2016/0185291 A1
(43) Pub. Date: Jun. 30, 2016

(54) SPEED-LIMIT-COMPLIANCE SYSTEM AND METHOD

(71) Applicant: Hand Held Products, Inc., Fort Mill, SC (US)

(72) Inventor: James W. Chamberlin, Tucker, GA (US)

(21) Appl. No.: 14/980,461

(22) Filed: Dec. 28, 2015

Related U.S. Application Data
(60) Provisional application No. 62/098,540, filed on Dec. 31, 2014.

(51) Int. Cl. B60Q 9/00; G01C 21/16; G01S 19/42

(52) U.S. Cl. CPC B60Q 9/00; G01S 19/42; G01C 21/16

(57) ABSTRACT

The speed-limit-compliance system for an industrial vehicle driven by an operator includes a wireless positioning module configured for determining the location within a facility of the industrial vehicle. The system also includes a speed sensor configured for determining the speed of the industrial vehicle. A process is in communication with the speed sensor and the wireless positioning module. When executed by the processor, computer readable program code stored in a non-transitory computer readable storage medium receives from the wireless positioning module the location of the industrial vehicle. The speed of the industrial vehicle is received from the speed sensor. A speed limit and an associated restricted speed zone are stored. A speed warning is generated when the industrial vehicle exceeds the speed limit while located within the restricted speed zone.

### CROSS-REFERENCE TO RELATED APPLICATION

The present application claims the benefit of U.S. Patent Application No. 62/098,540 for a Speed-Limit-Compliance System and Method filed on Dec. 31, 2014, which is hereby incorporated by reference in its entirety.

### FIELD OF THE INVENTION

The disclosure relates generally to industrial vehicles, and more particularly, to a speed-limit-compliance system and method for an industrial vehicle driven by an operator.

### BACKGROUND OF THE DISCLOSURE

Industrial vehicles are frequently used to transport materials and equipment in a facility. Many industrial vehicles are equipped with a vehicle-mount computer. These vehicle-mount computers are used to manage the activities of the operator of the industrial vehicle. For example, a vehicle-mount computer is frequently used to provide the operator with dispatch instructions, which instruct the operator where to pick up or deliver items using the industrial vehicle. The vehicle-mount computer may provide many other features, including navigational information relating to the facility.

As evidenced by the use of computers to facilitate the dispatch and navigation of industrial vehicles, speed and efficiency are important considerations in the management of industrial vehicle fleets. To maximize productivity, industrial vehicles should be dispatched and operated in a manner that allows for the fastest possible pickup and delivery of items. Because industrial vehicles are frequently operated in proximity to persons (e.g., workers), materials, and other equipment, it is also desirable to ensure that the industrial vehicle is being operated in a safe manner (e.g., at a safe travelling speed), thereby avoiding potential harm to persons or property. Furthermore, it is desirable to advise an operator of an industrial vehicle of areas and situations where greater care should be taken in the operation of the industrial vehicle.

What is needed is a computerized system capable of advising an operator of an industrial vehicle of the speed limit applicable to an area of a facility and taking corrective action when the operator fails to comply with the speed limit.

### SUMMARY OF THE INVENTION

In one aspect, the present disclosure embraces a speed-limit-compliance system for an industrial vehicle driven by an operator. The speed-limit-compliance system includes a speed sensor configured for determining the speed of the industrial vehicle. The system also includes a wireless positioning module configured for determining the location within the facility of the industrial vehicle. The system also includes a processor in communication with the speed sensor and the wireless positioning module. The system also includes a non-transitory computer readable storage medium (e.g., non-volatile memory) storing computer readable program code. When executed by the processor, the computer readable program code (i) receives from the wireless positioning module the location within the facility of the industrial vehicle; (ii) receives the speed of the industrial vehicle from the speed sensor; (iii) stores in the non-transitory computer readable storage medium a speed limit and an associated restricted speed zone; and (iv) generates a speed warning when the industrial vehicle exceeds the speed limit while located within the restricted speed zone.

In an exemplary embodiment, the wireless positioning module is a WLAN-based positioning module.

In another exemplary embodiment, the wireless positioning module is a GPS-based positioning module.

In yet another exemplary embodiment, the wireless positioning module is an RFID-based positioning module.

In yet another exemplary embodiment, the wireless positioning module is an inertial-navigation-based positioning module.

In yet another exemplary embodiment, the wireless positioning module is a UWB-based positioning module.

In yet another exemplary embodiment, the speed-limit-compliance system includes a display screen operatively coupled to the processor, and the speed warning includes a visual cue displayed on the display screen.

In yet another exemplary embodiment, the speed-limit-compliance system includes a speaker operatively coupled to the processor, and the speed warning includes an aural cue played through the speaker.

In yet another exemplary embodiment, the speed-limit-compliance system includes a warning light operatively coupled to the processor, and the speed warning includes illumination of the warning light.

In yet another exemplary embodiment, the speed-limit-compliance system includes a horn operatively coupled to the processor, and the speed warning includes sounding the horn.

In yet another exemplary embodiment, the speed-limit-compliance system includes a wireless network interface for transmitting and receiving information via a communications network.

In yet another exemplary embodiment, the computer readable program code, when executed by the processor transmits a non-compliance message to a remote computer via the communications network when the operator fails to comply with the speed warning.

In yet another exemplary embodiment, the non-compliance message is transmitted as an e-mail message.

In yet another exemplary embodiment, the non-compliance message is transmitted as a text message.

In yet another exemplary embodiment, the computer readable program code determines that the operator has not complied with a speed warning if, after the expiration of a pre-determined time period following the generation of the speed warning, (i) the industrial vehicle is located within the restricted speed zone and (ii) the industrial vehicle's speed exceeds the speed limit.

In yet another exemplary embodiment, the computer readable program code determines that the operator has not complied with a speed warning if the industrial vehicle's speed exceeds the speed limit a pre-determined number of instances following the generation of the speed warning.

In yet another exemplary embodiment, the computer readable program code, when executed by the processor, receives the speed limit and the associated restricted speed zone from a remote computer via the communications network.

In yet another exemplary embodiment, the remote computer is configured for setting the speed limit and the associated restricted speed zone based upon a remote computer user's input.

In another aspect, the disclosure embraces a non-transitory computer readable storage medium storing computer readable program code. When executed by a processor, the computer readable program code (i) receives from a wireless positioning module the location within the facility of an industrial vehicle, (ii) receives the speed of the industrial vehicle from a speed sensor, (iii) receives from a remote computer via a communications network a speed limit and an associated restricted speed zone, (iv) stores in the non-transitory computer readable storage medium the speed limit and the restricted speed zone, (v) stores in the non-transitory computer readable storage medium the speed limit and the restricted speed zone, and (vi) transmits a non-compliance message to the remote computer via the communications network when the operator fails to comply with the speed warning. The remote computer is configured for setting the speed limit and the speed restriction zone based upon a user's input.

In another aspect, the disclosure embraces a speed-limit-compliance method for an industrial vehicle driven by an operator. According to the speed-limit-compliance method, the location within the facility of the industrial vehicle is received from a wireless positioning module. The speed of the industrial vehicle is received from a speed sensor. A speed limit and an associated restricted speed zone is received from a remote computer via a communications network. The speed limit and the restricted speed zone is stored in a non-transitory computer readable storage medium. A speed warning is generated when the industrial vehicle exceeds the speed limit while located within the restricted speed zone.

A non-compliance message is transmitted to the remote computer via the communications network when the operator fails to comply with the speed warning. The remote computer is configured for setting the speed limit and the speed restriction zone based upon a user's input.

### BRIEF DESCRIPTION OF THE DRAWINGS

FIG. 1 is block diagram of an exemplary embodiment of a speed-limit-compliance system according to the present disclosure.

FIG. 2 is block diagram of an alternative embodiment of a speed-limit-compliance system according to the present disclosure.

FIG. 3 is block diagram of an alternative embodiment of a speed-limit-compliance system according to the present disclosure.

FIG. 4 is block diagram of an alternative embodiment of a speed-limit-compliance system according to the present disclosure.

FIG. 5 is block diagram of an alternative embodiment of a speed-limit-compliance system according to the present disclosure.

FIG. 6 is a block diagram of an alternative embodiment of a speed-limit-compliance system according to the present disclosure.

### DETAILED DESCRIPTION

The speed-limit-compliance system according to the present disclosure monitors the speed of an industrial vehicle being driven by an operator within a facility to determine whether the operator is abiding by the applicable speed limit or other applicable restrictions or guidelines associated with the operation of an industrial vehicle. Industrial vehicles include forklifts, pallet trucks, material handling vehicles, tow tractors, lift trucks, container handlers, orderpickers, sideloaders, stacker/retrieval machines, reach trucks, swing reach trucks, counterbalanced forklift vehicles, and similar vehicles driven (e.g., maneuvered, operated, controlled, etc.) by a human operator within a facility. Typically, these industrial vehicles are operated in a facility that includes a warehouse. Other types of facilities include ports, rail yards, trucking terminals, distribution centers, etc. A facility may include interior (e.g., inside) portions, exterior (e.g., outside) portions, or a combination of interior and exterior portions. Although utilization of the speed-limit-compliance system according to the present disclosure may be particularly useful within interior portions of a facility (e.g., within a warehouse), the disclosure is not limited to interior uses.

A system user selects a speed limit applicable to a restricted speed zone. A user may be the same person as the operator of the industrial vehicle, or a user may be a different person from the operator of the industrial vehicle. For example, a user of the system may be a supervisor or manager in charge of the fleet of industrial vehicles deployed at a facility. The system stores (e.g., in memory) the speed limit and the associated restricted speed zone.

A wireless positioning module determines the location of the industrial vehicle within the facility. The system provides the operator of the industrial vehicle with information about the speed limit applicable to the restricted speed zone. A speed sensor is used to monitor the speed of the industrial vehicle as the industrial vehicle is being driven by the operator within the facility. If the speed of the industrial vehicle, as determined by the speed sensor, exceeds the speed limit while the industrial vehicle is within the restricted speed zone, then the system issues a speed warning. If the operator persists in failing to abide by the applicable speed limit, the system may send information to a user (e.g., a supervisor, manager, etc.) regarding the operator's noncompliance with the speed limit.

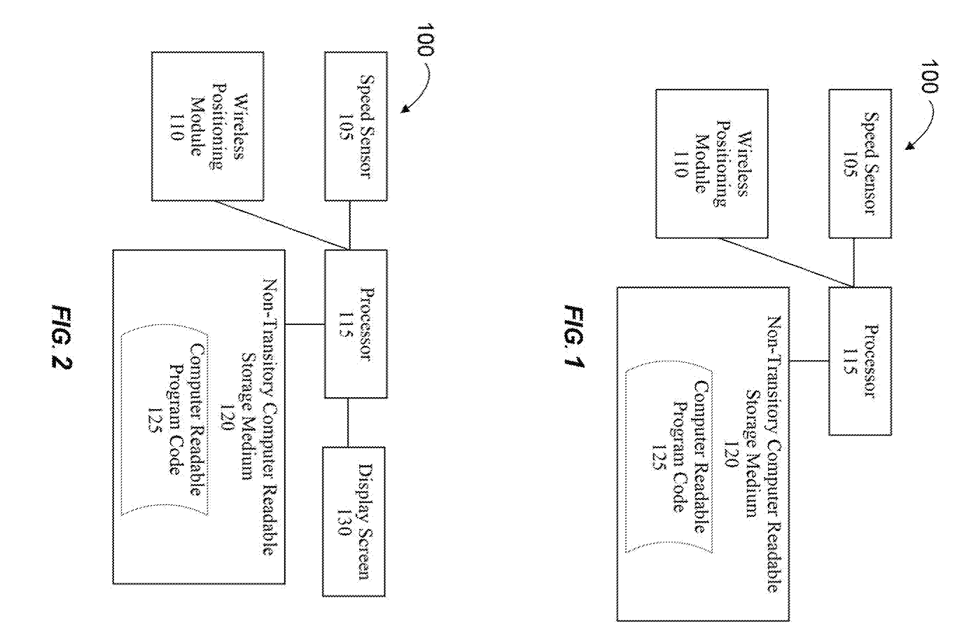

Referring to the figures in the accompanying drawings, the illustrative embodiments of the speed-limit compliance system according to the present invention will be described in great detail, where like elements will be indicated using like reference numerals. Turning now to the drawings, FIG. 1 is a block diagram of an exemplary speed-limit-compliance system 100 according to the present disclosure. The speed-limit-compliance system 100 is typically used in association with an industrial vehicle driven by an operator. Typically, the speed-limit-compliance system 100 is transported, at least in part, by the industrial vehicle. For instance, the speed-limit-compliance system 100 may be embodied, at least in part, in a vehicle-mount computer. Alternatively, the speed-limit-compliance system 100 may be embodied in another type of mobile device (e.g., tablet computer, handheld computer, barcode scanner or other indicia reader, wearable computer, etc.). The speed-limit-compliance system 100 may be fixably attached to the industrial vehicle (e.g., as a built-in dashboard component). Alternatively, the speed-limit-compliance system 100 may be removably attached to the industrial vehicle. In another embodiment, the speed-limit-compliance system may be separate from (i.e., not attached to) the industrial vehicle. For instance, the system 100 may be carried on the person of the operator or stowed inside the vehicle.

The system 100 includes a wireless positioning module 110. The wireless positioning module 110 is configured for determining the location within the facility of the industrial vehicle. As discussed, the facility may include indoor areas and/or outdoor areas. Therefore, the location within the facility of the industrial vehicle may be an indoor location or it may be an outdoor location. The wireless positioning module 110 may or may not be integral with the other components of the system 100. The wireless positioning module 110 may describe (e.g., categorize, classify, store, identify, etc.) the location of the industrial vehicle in any suitable manner. By way of example, and without intending to limit the present disclosure, the wireless positioning module 110 may describe the industrial vehicle's location through the use of coordinates such as geographic coordinates (e.g., longitude/latitude coordinates) or Cartesian coordinates (e.g., the selection of n coordinates for an n-dimensional Euclidean space). As an alternative example, the wireless positioning module 110 may describe the industrial vehicle's location by reference to components of the facility (e.g., an aisle, a road, a storage bin, a pickface, etc.) For instance, the wireless positioning module 105 may describe the location of the industrial vehicle as “aisle 17, rack C.” As will be discussed in greater detail below, the locating capabilities of the wireless positioning module 110 enable the system 100 to determine in which restricted speed zone, if any, the industrial vehicle is located.

Various techniques, either alone or in combination with each other, may be employed by the wireless positioning module 110 to determine the location of the industrial vehicle. In an exemplary embodiment, the wireless positioning module is an RFID-based positioning module. Passive RFID tags or active RFID tags may be used. Typically, active RFID tags are used due to their greater range (e.g., 20-40 meters). RFID tags may be positioned at various locations throughout the facility (e.g., on warehouse walls, shelving, equipment, etc.). As the industrial vehicle moves through the facility, the system's RFID-based positioning module, which may include an active RFID tag, interrogates the RFID tags, which reply with information relating to their location in the facility. The system's RFID-based positioning module may use the location information received from the RFID tags in conjunction with their signal strength to geolocate the industrial vehicle.

In another embodiment, the wireless positioning module 110 may be a WLAN-based positioning module that utilizes a wireless local area network (WLAN). Typically, a plurality of wireless access points, usually conforming to the IEEE 802.11 standard, are distributed throughout the facility. The WLAN-based positioning module measures the intensity of the signal (e.g., 2.4 GHz radio signal) emitted from the wireless access points to determine the location of the WLAN-based positioning module relative to the wireless access points, thereby geolocating the industrial vehicle. Typically, the positioning accuracy of the WLAN-based positioning module is between about 3 meters and 30 meters. The WLAN-based positioning module is usually able to update the position every few seconds (e.g., between about every 10 seconds and about every 20 seconds).

In another embodiment, the wireless positioning module utilizes global positioning system (GPS) technology. The system's GPS-based positioning module receives a radio signal from each of at least four GPS satellites orbiting the earth, each of which continuously transmits data, including their position and time. The GPS-based positioning module, which typically includes a GPS receiver, solves equations to determine the exact position of the receiver through triangulation. Because GPS technology typically requires unobstructed line-of-site between the GPS satellite and the GPS-based positioning module, a GPS-based positioning module is typically used in connection with outdoor facilities. Industrial vehicles operating inside (e.g., inside a warehouse or other building) are usually unable to receive a strong enough signal from enough GPS satellites to allow for geolocation using a GPS-based positioning module.

The system may also determine the location of the industrial vehicle within the facility using ultra-wideband (UWB) technology. In one embodiment, the wireless positioning module is a UWB-based positioning module. The use of UWB technology, which utilizes radio frequencies across a wide bandwidth (e.g., 500 MHz) has increased significantly since the United States Federal Communications Commission in 2002 opened up the spectrum between 3.1 GHz to 10.6 GHz. Whereas traditional RF-based systems transmit information by varying the power level, frequency, and/or phase of a sinusoidal wave, UWB transmissions generate radio energy at specific time intervals and occupying a large bandwidth. UWB signals typically are also transmitted for a much shorter duration than those used in conventional RF-based techniques. Furthermore, UWB can be used in close proximity to other RF signals without interfering with other RF-based systems (e.g., communication systems) because of the different signal types and radio spectrum used by UWB. The UWB-based positioning module functions in much the same way as an RFID-based positioning module in that the UWB-based positioning module interrogates UWB tags positioned at various fixed points in the facility. The UWB-based positioning module measures range and/or angle estimates to calculate the position of the industrial vehicle through multilateration or multiangulation. Utilization of UWB technology in this way can achieve geolocation to an accuracy of about 20 cm.

In another embodiment, the wireless positioning module 110 may be an inertial-navigation-based positioning module (e.g., inertial measurement unit or IMU). The inertial-navigation-based positioning module employs inertial navigation to determine the location of the industrial vehicle within the facility. Typically, the inertial-navigation-based positioning module includes an accelerometer to track the location of the industrial vehicle relative to a known starting point and velocity. The inertial-navigation-based positioning module may include other types of motion-sensing devices, such as a gyroscope. A benefit of the inertial-navigation-based positioning module is that it is not dependent upon the reception of radio signals from outside sources. Consequently, there are no issues regarding lines of site or signal strength. A drawback of utilizing inertial navigation techniques is integration drift. Integration drift occurs when small measurement errors compound themselves over time into larger positional errors. For this reason, the inertial-navigation-based positioning module is typically a supplement to other positioning techniques, including the RF-based techniques discussed above. For example, a GPS-based-positioning module may include an inertial-navigation-based positioning module.

The system 100 also includes a speed sensor 105. The speed sensor 105 is configured for determining the speed (e.g., traveling speed, ground speed, etc.) of an industrial vehicle driven by an operator. The speed sensor 105 may be any device suitable for determining the speed of the industrial vehicle. For example, the speed sensor 105 may be a mechanical or electronic gauge such as a speedometer (e.g., speed meter). Alternatively, the speed sensor 105 may be a positional speedometer, such as a Global Positioning Satellite (GPS) device, that calculates the speed of the industrial vehicle based upon how far the industrial vehicle has moved during a given time interval. In this regard, the speed sensor 105 may work in conjunction with, or may include, the wireless positioning module 110.

The speed-limit-compliance system 100 according to the present disclosure also includes a processor 115 (e.g., computer processor, central processing unit, microprocessor, etc.). The processor 115 is in communication with (e.g., communicatively coupled to) the wireless positioning module 101 and the speed sensor 105. In other words, the processor 115 is configured to receive location information from the wireless positioning module 110 and to receive speed information from the speed sensor 105. The connection between the processor 115 and both the wireless positioning module 110 and the speed sensor 105 may be wired or wireless (e.g., 802.11, Bluetooth, etc.). Typically, the processor 115 is communicatively coupled to a computer bus, which facilitates communication between the processor 115 and the other components of the system 100.

The system 100 also includes a non-transitory computer readable storage medium 120. Typically, the non-transitory computer readable storage medium 120 is in communication with the processor 115, usually via the computer bus. The non-transitory computer readable storage medium 120 may be any type of hardware suitable for storing computer-readable information, including one or more of the following: magnetic discs, hard drives, solid state drives, flash drive, optical discs, CD-ROMs, DVD-ROMs, tape drives, and barcodes. The non-transitory computer readable storage medium 120 stores a computer readable program code 125 (e.g., computer software). The computer readable program code 125 may be any form of instructions that can be read (e.g., understood, processed by) the processor 115. For example, the computer readable program code 125 may be composed (e.g., created) using any of a variety of standard programming languages, individually or in combination with other programming languages, designed to communicate instructions to the processor 115, including without limitation C++, COBOL, Java, etc. Typically, the software code is converted into machine language (e.g., by a compiler) for processing by the processor 115.

When executed by the processor 115, the computer readable program code 125 receives (e.g., receives as an object, data input, etc.) from the wireless positioning module 110 the location within the facility of the industrial vehicle. Additionally, when executed by the processor 115, the computer readable program code 125 receives the speed of the industrial vehicle from the speed sensor 105. Typically, the computer readable program code 125 receives the speed of the industrial vehicle in real time. In other words, the speed sensor 105 is substantially continuously (e.g., every few milliseconds or seconds (e.g., between about 1 second and about 10 seconds) updating the computer readable program code 125 with the substantially current speed of the industrial vehicle. The computer readable program code 125 should receive the speed of the industrial vehicle substantially in real time. If the computer readable program code 125 were to receive the speed from the speed sensor 105 on too great of a delay (e.g., a delay of greater than about 5 seconds), then the system 100 may not have the updated information required to provide accurate and/or adequate warnings to the operator of the industrial vehicle.

A speed limit and an associated restricted speed zone are stored in the non-transitory computer readable storage medium. Typically, the speed limit is stored as a numerical unit value (e.g., miles per hour, kilometers per hour, etc.). The speed limit is usually a designation of the maximum speed at which an industrial vehicle is permitted to travel when within a particular speed zone within the facility. For example, the speed limit could be 5 miles per hour. Assuming a given industrial vehicle has a maximum speed that is greater than the speed limit, an operator would need to ensure that the industrial vehicle's speed is limited to a speed that is no greater than the speed limit to comply with the speed limit.

As mentioned, the speed limit is associated with a restricted speed zone. The restricted speed zone is at least a portion of the facility to which the speed limit applies. The restricted speed zone may be the entire facility. Where the restricted speed zone is the entire facility, the speed limit represents a facility-wide speed limit. There may be multiple restricted speed zones for a particular facility. For example, the computer readable program code 125 may store in the non-transitory computer readable storage medium 120 five separate restricted speed zones, with each restricted speed zone having its own speed limit. Each restricted speed zone may have a different speed limit, or some or all restricted speed zones may have the same speed limit. For example, a first restricted speed zone may have a speed limit of 5 miles per hour and a second restricted speed zone may have a speed limit of 15 miles per hour.

The computer readable program code 125 is further configured such that, when it is executed by the processor 115, a speed warning is generated when the industrial vehicle exceeds the speed limit while located within the associated restricted speed zone. A speed warning may be any information relating to the speed limit and associated restricted speed zone. Typically, a speed warning is a notification of the speed limit that is applicable to the restricted speed zone within which the industrial vehicle is located. For example, when the industrial vehicle enters a restricted speed zone, the system 100 generates a speed warning that advises the operator of the industrial vehicle of the applicable speed limit for the restricted speed zone. The speed warning may also be generated when the industrial vehicle is located substantially proximate to the restricted speed zone. For example, the speed warning may be generated as the industrial vehicle is approaching the restricted speed zone.

Alternatively, or in addition, the speed warning generated by the system 100 may advise the operator of the industrial vehicle that the present speed of the industrial vehicle exceeds the speed limit. By way of further example, where the system 100 is in communication with the industrial vehicle proper, the speed warning may be a command that automatically reduces the speed of the industrial vehicle until the speed is less than or equal to the speed limit.

As shown in FIG. 2, in one exemplary embodiment, the system 100 according to the present disclosure includes a display screen 130. The display screen 130 is operatively coupled to the processor 115. Typically, the display screen 130 is able to display text and/or graphic information as instructed by the processor 115. The display screen 130 may be, by way of example, an LCD screen or a transparent LCD screen. The display screen 130 may be a touchscreen that allows for the input of information (e.g., instructions) by touching a specific area of the display screen 130. Where the system 100 includes a display screen 130, the speed warning may include a visual cue displayed on the display screen 130. For example, as the industrial vehicle approaches or enters a restricted speed zone, the display screen 130 may display a message for the operator, such as “Speed Limit 15 mph.” Alternatively, the speed warning be a graphic displayed on the display screen 130, such as a down arrow and/or pre-determined color indicating a reduction in speed is required to comply with the speed limit.

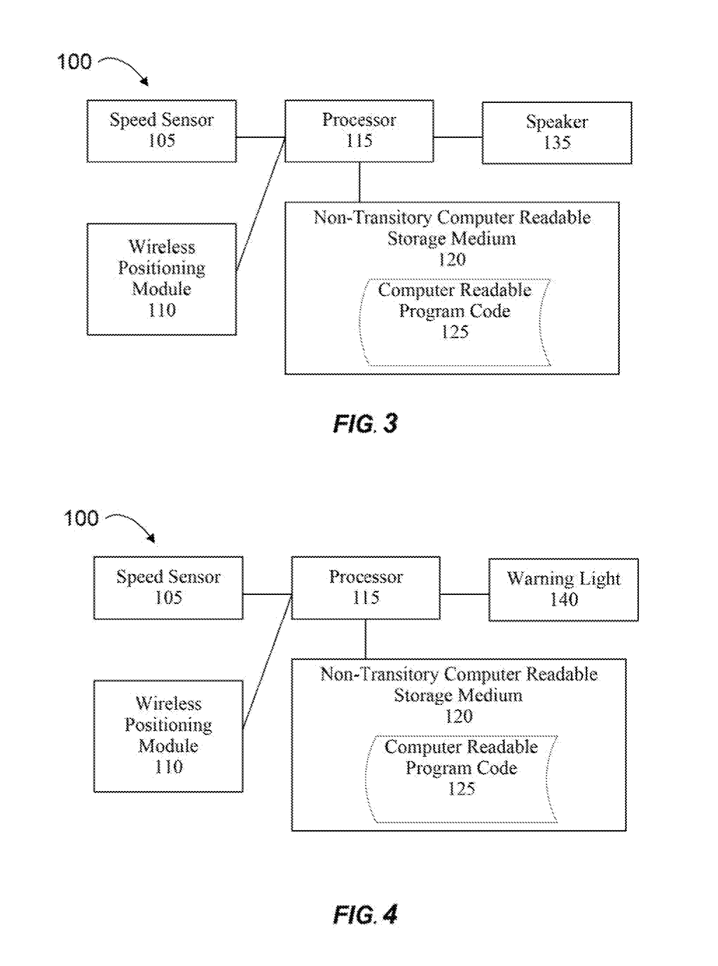

In an alternative embodiment depicted in FIG. 3, the speed-limit-compliance system 100 according to the present disclosure includes a speaker 135. The speaker is operatively coupled to the processor 115. When the system generates a speed warning, the speed warning is communicated to the operator of the industrial vehicle at least in part through an aural cue played through the speaker. For example, the system may cause a sound file (e.g., .wav file, mp3 file, or other audio file) to be played through the speaker 135 advising the operator with the spoken words “Entering restricted speed zone. Speed limit 10 miles per hour.” Alternatively, the aural cue may be a pre-determined sound associated with a speed warning, such as a buzzing sound, bell sound, or other aural cue sufficient to alert the operator of an applicable speed limit.

In an alternative embodiment depicted in FIG. 4, the speed-limit-compliance system 100 according to the present disclosure includes a warning light 140. The warning light 140 is operatively coupled to the processor 115. When a speed warning is generated by the system, the processor 115 causes the warning light 140 to illuminate. The warning light 140 may include one light or multiple lights. For example, a yellow light may illuminate to signify that the industrial has entered a restricted speed zone, and a red light may illuminate to indicate that the industrial vehicle is exceeding the speed limit.

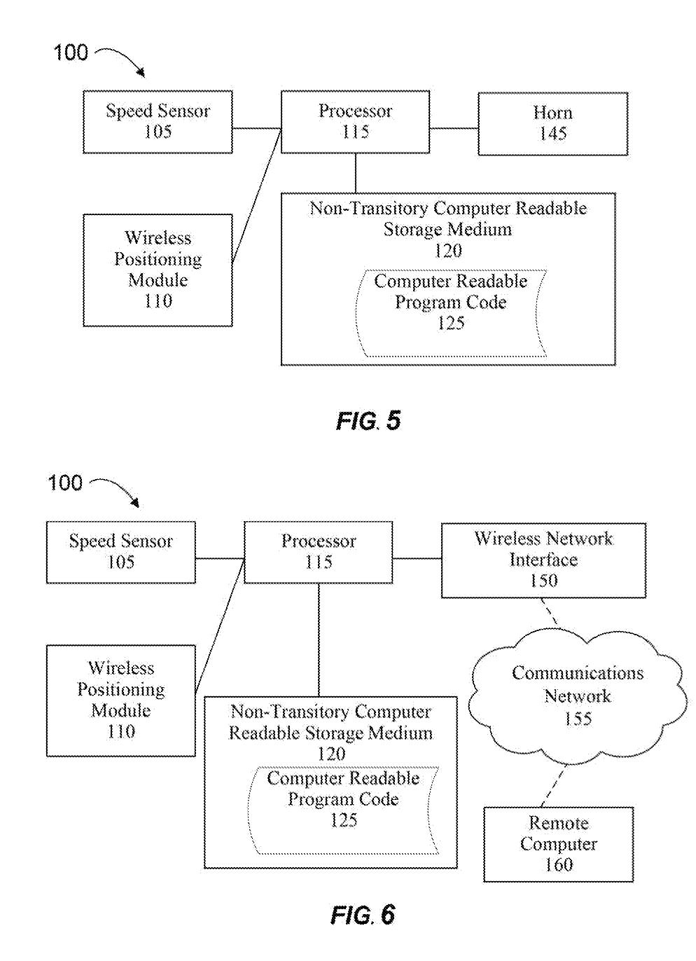

In another alternative embodiment depicted in FIG. 5, the speed-limit-compliance system 100 according to the present disclosure includes a horn 145. The horn 145 is operatively coupled to the processor 115 such that when a speed warning is generated, the processor 115 causes the horn to produce a sound sufficient to alert the operator. For example, when an industrial vehicle enters a restricted speed zone, the horn may play one continuous sound to alert the operator that the operation is now governed by a speed limit. By way of further example, when the industrial vehicle exits a restricted speed zone, the horn may play two distinct sounds (e.g., sequential horn blasts) to indicate that the industrial vehicle is leaving a restricted speed zone.

In an alternative embodiment of the speed-limit-compliance system 100 according to the present disclosure, the system includes a wireless network interface 150. The wireless network interface 150 allows the system 100 to communicate (e.g., transmit and receive information) with other networked computers and devices via a communications network 155. The wireless network interface 150 may be any suitable network interface (e.g., network interface card (NIC)) suitable for communicating over the communications network 155. The communications network may be any type of computer network, including a wireless local area network, wireless personal area network, a wide area network, or any combination thereof.

For example, the system 100 may, using the wireless network interface 150, communicate via the communications network 155 with a remote computer 160. Typically, the remote computer 160, which may be a collection of computer workstations or other devices (e.g., smartphone, pager, wearable computer, etc.), is accessible by a system user (e.g., a supervisor, manager, or other person overseeing the operation of the industrial vehicle). The system's computer readable program code 125, when executed by the processor 115, may transmit a non-compliance message to the remote computer 160 via the communications network 155 when the operator of the industrial vehicle fails to comply with a speed warning.

The non-compliance message may be any type of communication that alerts the user (e.g., remote user, supervisor, manager, etc.) that the operator of the industrial vehicle has failed to comply with a speed warning. For example, the system 100 may cause an e-mail message to be sent to the remote computer 160, wherein the e-mail message contains text and or graphics sufficient to advise the reader of the e-mail (e.g., the user) that a violation of the speed limit has occurred. In the alternative and by way of further example, the non-compliance message may be a text message (e.g., SMS text message).

The system 100 may use various criteria to determine whether the operator of the industrial vehicle has complied with a speed warning issued by the system. In one embodiment, the computer readable program code 125 determines that the operator has not complied with a speed warning if, after expiration of a pre-determined time period (e.g., between about 15 seconds and about 30 seconds) following the generation of the speed warning, (i) the industrial vehicle is located within the restricted speed zone and (ii) the industrial vehicle's speed exceeds the speed limit. This approach allows time for the industrial vehicle's operator to adjust the speed of the industrial vehicle following the generation of a speed warning. Alternatively, the computer readable program code 125 may determine that the operator has not complied with a speed warning if the industrial vehicle's speed exceeds the speed limit a pre-determined number of instances (e.g., between about 3 instances and 5 instances)) following the generation of the speed warning. This approach is geared more toward notifying a system user, such as a supervisor, when an operator habitually fails to comply with a speed warning.

As mentioned above, the system 100 stores the speed limit and associated restricted speed zone. Information regarding the speed limit and associated speed zone may be entered directly into the system 100, for example using an input device such as a touchscreen-style display screen 130 or a traditional keyboard operatively coupled to the processor 115. In this way, an operator of an industrial vehicle may, for example, enter speed limit and/or restricted speed zone information while inside or proximate to the industrial vehicle. More typically, the speed limit and restricted speed zone entered into the remote computer 160, which then transmits the information to the system 100. Typically, a user, such as a supervisor, enters the speed limit and restricted speed zone into the remote computer 160 (e.g., using the remote computer's keyboard), and the remote computer 160 transmits the information via the communications network 155. The system's computer readable program code 125, when executed by the processor, receives the speed limit and the associated restricted speed zone from the remote computer 160 via the communications network and stores the information in the non-transitory computer readable storage medium 120.

In this way, a user (e.g., remote user, supervisor, etc.) may remotely and continuously update the speed limit(s) and restricted speed zone(s). This may be particularly beneficial in facilities that experience changing environments. For example, if a particular area of the facility experiences greater-than-normal congestion, a user may wish to designate that area as a restricted speed zone having a speed limit. Similarly, a user might wish to institute a speed limit for a certain area of a facility that experienced a spill making the traveling surface (e.g., floor) more slippery than normal. In this way, restricted speed zones may be constant or static. A user may create or modify restricted speed zones as frequently or infrequently as desired.

The present disclosure also embraces a speed-limit-compliance method. Typically, the speed-limit-compliance method according to the present disclosure is embodied in a non-transitory computer readable storage medium having stored therein a computer readable program code that, when executed by a processor, carries out the steps of the method. According to the present speed-limit-compliance method, the location within the facility of the industrial vehicle is received from a wireless positioning module. The speed of the industrial vehicle is received from the speed sensor. The speed limit and an associated restricted speed zone is received from the remote computer via the communications network. The speed limit and restricted speed zone are stored in the non-transitory computer readable storage medium. A speed warning is generated when the industrial vehicle exceeds the speed limit while located within the restricted speed zone. A non-compliance message is transmitted to the remote computer via the communications network when the operator fails to comply with the speed warning.

To supplement the present disclosure, this application incorporates entirely by reference the following patents, patent application publications, and patent applications:

To supplement the present disclosure, this application incorporates entirely by reference the following patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and figures, typical embodiments of the invention have been disclosed. The present invention is not limited to such exemplary embodiments. Unless otherwise noted, specific terms have been used in a generic and descriptive sense and not for purposes of limitation.

What is claimed is:

1. A speed-limit-compliance system for an industrial vehicle driven by an operator, comprising:
a wireless positioning module configured for determining the location within a facility of the industrial vehicle;
a speed sensor configured for determining the speed of the industrial vehicle;
a processor in communication with the speed sensor and the wireless positioning module;
a non-transitory computer readable storage medium storing computer readable program code, wherein, when executed by the processor, the computer readable program code:
receives from the wireless positioning module the location within the facility of the industrial vehicle;
receives the speed of the industrial vehicle from the speed sensor;
stores in the non-transitory computer readable storage medium a speed limit and an associated restricted speed zone; and
generates a speed warning when the industrial vehicle exceeds the speed limit while located within the restricted speed zone.

2. The speed-limit-compliance system of claim 1, wherein the wireless positioning module is a WLAN-based positioning module.

3. The speed-limit-compliance system of claim 1, wherein the wireless positioning module is a GPS-based positioning module.

4. The speed-limit-compliance system of claim 1, wherein the wireless positioning module is an RFID-based positioning module.

5. The speed-limit-compliance system of claim 1, wherein the wireless positioning module is a UWB-based positioning module.

6. The speed-limit-compliance system of claim 1, wherein the wireless positioning module is an inertial-navigation-based positioning module.

7. The speed-limit-compliance system of claim 1, comprising:
a display screen operatively coupled to the processor;
wherein the speed warning includes a visual cue displayed on the display screen.

8. The speed-limit-compliance system of claim 1, comprising:
a speaker operatively coupled to the processor;
wherein the speed warning includes an aural cue played through the speaker.

9. The speed-limit-compliance system of claim 1, comprising:
a warning light operatively coupled to the processor;
wherein the speed warning includes illumination of the warning light.

10. The speed-limit-compliance system of claim 1, comprising:
a horn operatively coupled to the processor;
wherein the speed warning includes sounding the horn.

11. The speed-limit-compliance system of claim 1, comprising a wireless network interface for transmitting and receiving information via a communications network.

12. The speed-limit-compliance system of claim 11, wherein the computer readable program code, when executed by the processor, transmits a non-compliance message to a remote computer via the communications network when the operator fails to comply with the speed warning.

13. The speed-limit-compliance system of claim 12, wherein the non-compliance message is transmitted as an e-mail message.

14. The speed-limit-compliance system of claim 12, wherein the non-compliance message is transmitted as a text message.

15. The speed-limit-compliance system of claim 12, wherein the computer readable program code determines that the operator has not complied with a speed warning if, after the expiration of a pre-determined time period following the generation of the speed warning, (i) the industrial vehicle is located within the restricted speed zone and (ii) the industrial vehicle's speed exceeds the speed limit.

16. The speed-limit-compliance system of claim 12, wherein the computer readable program code determines that the operator has not complied with a speed warning if the industrial vehicle's speed exceeds the speed limit a pre-determined number of instances following the generation of the speed warning.

17. The speed-limit-compliance system of claim 11, wherein the computer readable program code, when executed by the processor, receives the speed limit and the associated restricted speed zone from a remote computer via the communications network.

18. The speed-limit-compliance system of claim 17, wherein the remote computer is configured for setting the speed limit and the associated restricted speed zone based upon a remote computer user's input.

19. A non-transitory computer readable storage medium storing computer readable program code, wherein, when executed by a processor, the computer readable program code:
receives from a wireless positioning module the location within the facility of an industrial vehicle;
receives the speed of the industrial vehicle from a speed sensor;
receives from a remote computer via a communications network a speed limit and an associated restricted speed zone;
stores in the non-transitory computer readable storage medium the speed limit and the restricted speed zone;
generates a speed warning when the industrial vehicle exceeds the speed limit while located within the restricted speed zone; and
transmits a non-compliance message to the remote computer via the communications network when the operator fails to comply with the speed warning;
wherein the remote computer is configured for setting the speed limit and the speed restriction zone based upon a user's input.

20. A speed-limit-compliance method for an industrial vehicle driven by an operator, comprising:
receiving from a wireless positioning module the location within a facility of the industrial vehicle;
receiving the speed of the industrial vehicle from a speed sensor;
receiving from a remote computer via a communications network a speed limit and an associated restricted speed zone;
storing in a non-transitory computer readable storage medium the speed limit and the restricted speed zone;
generating a speed warning when the industrial vehicle exceeds the speed limit while located within the restricted speed zone; and
transmitting a non-compliance message to the remote computer via the communications network when the operator fails to comply with the speed warning;
wherein the remote computer is configured for setting the speed limit and the speed restriction zone based upon a user's input.
